(19) United States
(12) Patent Application Publication
(10) Pub. No.: US 2021/0004448 A1
(43) Pub. Date: Jan. 7, 2021

(54) IMAGE PASSWORD SYSTEM AND USER AUTHENTICATION METHOD USING SAME

(71) Applicant: Myeong Ho Lee, Bucheon (KR)

(72) Inventor: Soo Hyun Lee, Bucheon (KR)

(73) Assignee: Myeong Ho Lee, Bucheon (KR)

(21) Appl. No.: 16/434,282

(22) Filed: Jun. 7, 2019

Related U.S. Application Data
(63) Continuation-in-part of application No. PCT/KR2017/014316, filed on Dec. 7, 2017.

(30) Foreign Application Priority Data
Dec. 7, 2016 (KR) 10-2016-0166149

(51) Int. Cl. G06F 21/36; G06F 3/0481; G06F 21/46

(52) U.S. Cl. CPC G06F 21/36; G06F 21/46; G06F 3/04817

(57) ABSTRACT

Provided are a user authentication method and a supplementary service providing method. The user authentication method and the supplementary service providing method using an image password system according to an embodiment of the present invention include receiving a selection signal through an area of an image, extracting code information indicated by the selection signal among specific components constituting the image, generating a password using the extracted code information, and determining the validity of the password according to whether or not the password matches a preset password. Accordingly, as inputting a password and requesting authentication through selection of components of an image, the present invention is convenient for a user and has high security. Also, a user easily remembers a password, and the password is easy to change. In addition, the authentication screen can be configured with images such as favorite photographs, pictures and characters.

### TECHNICAL FIELD

The following disclosure relates to a method for performing a user authentication process by setting and inputting a password using an image.

### BACKGROUND ART

A password authentication method is used as a universal method for user authentication. In the password authentication method, a password inputted from a user as the initial setting is stored, and then a password inputted from a user is compared with the pre-stored password whenever necessary. When the passwords are identical to each other, it is determined that the password authentication is successful.

However, passwords may be exposed in various ways. For example, a third party may watch the password input process of a user and find out the password. A hacking program may also hack the password inputted from a user terminal to find out the password. In addition, it is also possible to obtain a password by taking the password from data during the network communication.

Accordingly, it is necessary to develop a new password authentication technology that prevents a third party from recognizing the password even if the password is exposed to the third party, or makes the obtained password unusable.

### DISCLOSURE

### Technical Problem

Accordingly, the present disclosure provides a new user authentication method, which allows a user to feel no repulsion and easily remember a password by selecting components of an image to input a password and request authentication and thus by configuring a password input screen with an image such as a user's favorite character, picture and photograph.

### Technical Solution

In one general aspect, a user authentication method using an image password system executed in a terminal device, the method includes: receiving a selection signal through an area of an image; extracting code information indicated by the selection signal from an area of a layer disposed so as to correspond to the image; generating a password using the extracted code information; and determining the validity of the password according to whether or not the password matches a preset password.

In another general aspect, an image password system includes: a service providing server providing an image identifier to a terminal device in accordance with a request for a service by the terminal device and when a password is received from the terminal device, determining the validity of the password according to whether or not the password matches a preset password to provide the service; and a terminal device extracting an image corresponding to the image identifier and a layer corresponding to the image from image and layer information tables received and stored in advance from the service providing server, arranging the image and the layer so as to correspond to each other, receiving a selection signal through an area of the image, extracting code information indicated by the selection signal from an area of the layer disposed so as to correspond to the image, generating a password using the corresponding code information, and then providing the password to the service providing server. Other features and aspects will be apparent from the following detailed description, the drawings, and the claims.

### Advantageous Effects

According to an embodiment of the present invention, a user can feel no repulsion and easily remember a password by selecting components of an image to input a password and request authentication and thus by configuring a password input screen with an image such as a user's favorite character, picture and photograph.

According to an embodiment of the present invention, since it is possible to decorate the password input screen with user's favorite characters, cartoon cuts, pictures, photographs, emoticons, avatars and the like, his/her own unique input screen can be configured.

According to an embodiment of the present invention, since user use input screens to which different images are applied and the password input buttons are not displayed to the outside, it is difficult to guess the password even though the password is exposed. Accordingly, the security for the password guessing attack and the shoulder surfing can be improved. When a plurality of images are together used on the password input screen, there is no way to know the real input screen, thereby significantly increasing security through a secondary security.

According to an embodiment of the present invention, since images such as characters, pictures, and photographs are used, the convenience and security can be increased at the same time based on the Graphic Image Password (GIP) system that utilizes all the knowledge and emotional characteristics such as the user's experience, learning, emotion and feeling.

According to an embodiment of the present invention, when an image is changed by a user, the code information of the corresponding area is automatically changed together. Accordingly, there is no inconvenience to newly create a new password and newly remember the password whenever the password is changed.

Accordingly, passwords can be easily and conveniently replaced to enhance security, thereby preventing the password from being exposed or hacked in advance.

According to an embodiment of the present invention, a dummy password can be randomly inputted before and/or after inputting a password. Accordingly, even if a password is exposed to a third party, the third party cannot remember or predict the password, thereby enhancing the password protection effect and preventing the exposure to surroundings and the shoulder surfing.

According to an embodiment of the present invention, a typographic image that is an image of a number or a character can be used in an image. Accordingly, unlike a virtual keyboard in which the character string and spacing are randomly changed, an effect of preventing keylogging can be obtained while maintaining the order of the character string and the character spacing. Thus, the user convenience and security can be together improved by preventing exposure due to user's password input error or input time delay.

According to an embodiment of the present invention, when a supplementary service providing method using an image password system is applied to a terminal device, various kinds of user's convenience can be enhanced and functions can be expanded.

### DESCRIPTION OF DRAWINGS

FIG. 1 is a network configuration view illustrating an image password system according to an embodiment of the present invention.

FIGS. 2 to 4 are views illustrating a user authentication process using an image password system according to an embodiment of the present invention. More specifically, FIG. 2 illustrates a process for mapping multiple units of a layer to multiple units of an image according to an embodiment of the present invention, FIG. 3A illustrates a process for generating passwords for two different images according to an embodiment of the present invention, FIG. 3B illustrates a process for changing a password by using a different background image according to an embodiment of the present invention; and FIG. 4 illustrate a process for generating a password that including a dummy password according to an embodiment of the present invention.

FIGS. 5 to 9 are views illustrating a user authentication process using an image password system using a numerical image and a photographic image according to an embodiment of the present invention. More specifically, FIG. 5 shows three exemplary images for generating passwords according to an embodiment of the present invention; FIG. 6 shows a process of mapping “3” in an image to three different layers according to an embodiment of the present invention; FIG. 7 shows a process of mapping “2” in an image to three different layers according to an embodiment of the present invention; FIG. 8 shows exemplary layouts of characters according to an embodiment of the present invention; FIG. 9A shows a process of mapping a picture image to a layout according to an embodiment of the present invention; and FIG. 9B shows dummy images disposed around an image that is used to generate a password according to an embodiment of the present invention.

FIGS. 10 to 13 are views illustrating a supplementary service providing method using an image password system according to another embodiment of the present invention. More specifically, FIG. 10 shows multiple icons superimposed on an image according to an embodiment of the present invention; FIG. 11 shows a process of displaying a telephone application in response to a user's touch on an image according to an embodiment of the present invention; FIG. 12 shows a process for setting shortcut keys on an image according to an embodiment of the present invention; and FIG. 13 shows a supplementary service providing method using an image password system according to an embodiment of the present invention.

FIG. 14 is a view illustrating a supplementary service providing method using an image password system according to another embodiment of the present invention.

FIG. 15 is a view illustrating a supplementary service providing method using an image password system according to another embodiment of the present invention.

### BEST MODE

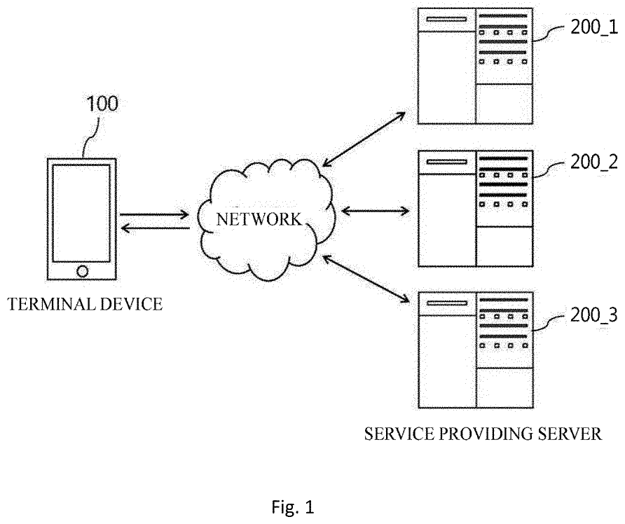

Referring to FIG. 1, an image password system includes a terminal device 100 and a service providing server 200.

The terminal device 100 may independently provide user authentication and supplementary services using an image password system or may receive services through a user authentication process using the image password system in linkage with the service providing server 200.

The terminal device 100 may be implemented with an automated device such as a smart phone, a PDA, a tablet PC, a notebook PC, a desktop PC, a game machine, a smart TV, and an Automated Teller Machine (ATM), and may be a plurality of remote terminals, smart watches or other wearable devices.

Alternatively, the terminal device 100 may be an IoT controller which is connected to a wireless communication network and controls various Internet of Things (IoT) products by a short-range wireless communication method such as Bluetooth or Zigbee. In addition, the terminal device 100 may be a form of a mobile device such as a smart phone or a tablet computer interlocked with various IoT products.

In addition, if the above definition is satisfied, there is no limitation in the type of hardware.

When the terminal device 100 independently provides user authentication and supplementary services using the image password system, the terminal device 100 unlocks the mobile phone and provides supplementary services according to the validity of the password.

When the terminal device 100 operates in linkage with the service providing server 200, the terminal device 100 extracts an image already received and stored from the service providing server 200, an image corresponding to an identifier and a layer corresponding to the image from a layer information table and arranges such that the image and the layer correspond to each other if the terminal device 100 receives the image identifier from the service providing server 200.

Thus, the terminal device 100 arranges a layer 220 including a plurality of units 240 based on the layer information received from the service providing server 200, and then arranges code information in each unit of the layer. Thus, even if the layer of the service providing server 200 is changed, the same layer as the layer of the service providing server 200 can be maintained.

When the code information of each unit of the layer arranged to correspond to the image in the service providing server 200 is changed, the terminal device 100 receives layer information from the service providing server 200. By arranging the layer based on the layer information received from the service providing server 200 and rearranging the code information in each unit of the layer according to the code information, even if the layer of the service providing server 200 is changed, the same layer as the layer of the providing server 200 can be maintained.

In addition, when the image is changed by a user, the terminal device 100 provides a changed image identifier to the service providing server 200. Accordingly, since the service providing server 200 extracts an image corresponding to the image identifier received from the terminal device 100 and a layer corresponding to the image from the image and layer information table and arranges the image and the layer such that the image and the layer correspond to each other, the same image and layer as the image and the layer of the terminal device 100 can be maintained even if the image is changed in the terminal device 100.

The terminal device 100 receives a selection signal by touch of the image area, extracts code information of a unit indicated by the selection signal in the layer area arranged in correspondence with the image, generates a password using the corresponding code information, and then provides the password to the service providing server 200.

In this case, if a password input completion signal (e.g., Enter input signal) is received, the terminal device 100 may generate a password using the extracted code information, or if the selection signal is not received for a specific time, the terminal device may generate a password using the extracted code information.

The terminal device 100 provides the password to the service providing server 200, and may be provided with a service from the service providing server 200 according to the authentication result by the service providing server 200.

The service providing server 200 provides an image identifier to the terminal device 100 according to a service request by the terminal device 100.

The service providing server 200 arranges the code information including at least one of numerals, letters (including upper and lower case letters), special characters and symbols in each of a plurality of unit areas of the layer. The code information arranged in each of the plurality of units of the layer is randomly changed at specific time intervals, randomly changed by the number of times, or randomly changed over time based on One Time Password (OTP).

In this case, whenever the code information arranged in each unit of the layer is changed, the service providing server 200 provides the changed layer information to the terminal device 100. The terminal device 100 configures a layer based on the layer information received from the service providing server 200 and rearranges the code information in each unit. Thus, even if the layer information of the service providing server 200 is changed, the same layer information as that of the second layer 200 can be maintained.

Also, when the image is changed by a user in the terminal device 100, the service providing server 200 receives the changed image identifier from the terminal device 100. Accordingly, the service providing server 200 extracts an image corresponding to the image identifier received from the terminal device 100 and a layer corresponding to the image from the image and layer information table, and arranges the layer and the image such that the image and the layer correspond to each other.

Thus, even if the image is changed in the terminal device 100, the service providing server 200 can maintain the same image and the layer as the image and the layer of the terminal device 100 by arranging the image and layer so as to correspond to each other based on the image identifier received from the terminal device 100.

In addition, when the password is received from the terminal device 100, the service providing server 200 determines the validity of the password according to whether or not the received password matches a preset password, and provides the service.

The service providing server 200 may be changed according to the type of service provided to the terminal device 100. The type of service may include at least one of a financial transaction service, a payment service, a card payment service, and a user authentication service. That is, the service providing server 200 may include all services provided after user authentication on-line.

### Mode for Invention

Hereinafter, a user authentication method in which the terminal device 100 independently uses the image password system will be described. When the terminal device 100 is executed in linkage with the service providing server 200, a portion of the functions of the terminal device 100 may be executed in the service providing server 200.

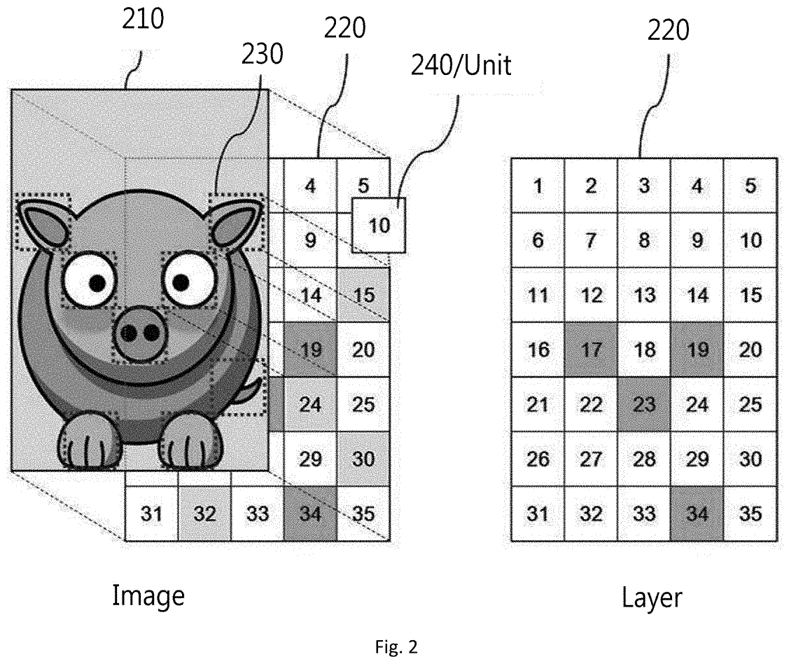

Referring to FIGS. 2 to 4, the terminal device 100 generates a layer 220 including a plurality of units 240 so as to correspond to a plurality of components 230 (specific areas of an image, e.g., an ear, an eye, a nose, a cheek, a foot, a tail, etc. of a pig character) constituting an image 210, and arranges the layer 220 so as to correspond to the image 210 as shown in FIG. 2.

In this case, the layer 220 as a virtual layer is not visually displayed, and code information is arranged in each of the unit areas configured by a block style. The code information may include at least one of numerals, letters (including upper and lower case letters), special characters, and symbols.

The number of the units 240 constituting the layer 220 is not limited to 5×7, but may be freely configured as 6×8, 7×9 and the like. That is, the larger the number of units in the layer 220 is, the smaller the area width of the unit becomes, enabling a user to select a smaller and more detailed portion and more portions from the image 210 disposed corresponding to the layer 220.

Since the unit 240 of the layer 220 corresponds to the component 230 on the image 210 and different code information is arranged in each of the units 210, a user selects the code information of the unit 240 by selecting the component on the image 210.

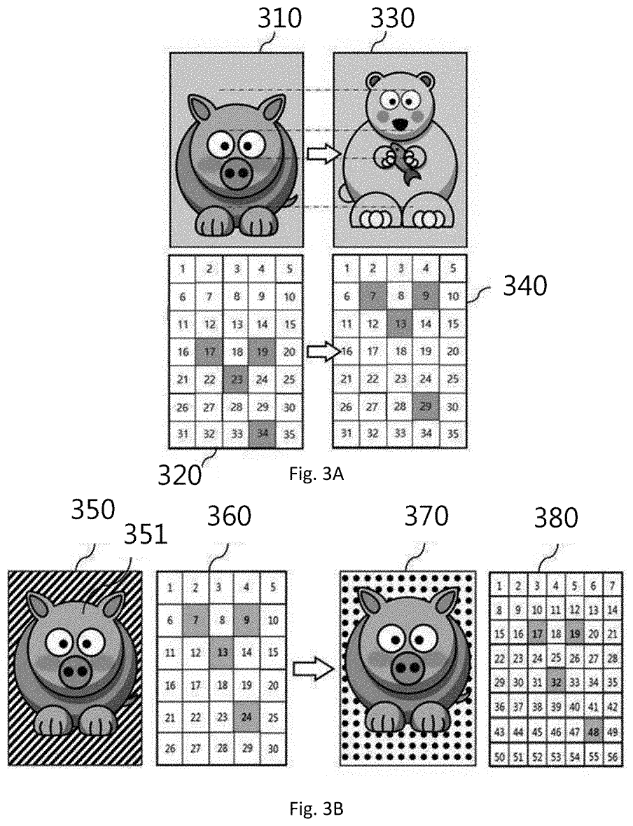

For example, as shown in FIG. 3A, when a password preset by a user is “left eye→right eye→nose→right foot” among the plurality of components constituting the pig character 310, the password is set to “17, 19, 23, 34” which is a combination of code information “17” of the unit corresponding to “left eye”, code information “19” corresponding to “right eye”, code information “23” corresponding to “nose” and code information “34” corresponding to “right foot”.

In the above example, when the image of the pig character 310 is changed by a user to a white bear character 330, the password pre-designated by a user maintains the “left eye→right eye→nose→right foot”. However, since the positions of the left eye, the right eye, the nose, and the right foot of the pig character 310 and the white bear character 330 on the images are different from each other, the layers 320 and 340 arranged so as to correspond to the images 310 and 330 are identical, but the units of different positions are selected, and thus the password is changed.

That is, when the pig character image 310 is changed to the white bear character 330 by a user, the password is set to “7, 9, 13, 29” which is a combination of code information “7” of the unit corresponding to “left eye”, code information “9” corresponding to “right eye”, code information “13” corresponding to “nose” and code information “29” corresponding to “right foot” in the layer 340 arranged so as to correspond to the white bear character 330, and thus the password is changed from “17, 19, 23, 34” to “7, 9, 13, 29”.

Accordingly, a user remembers and uses only “left eye, right eye, nose, right foot” which are partial images (components) of the image necessary for inputting the password. Even if the image is changed to another image, a user identically inputs “left eye, right eye, nose, right foot” without a change, but the password input value is automatically changed.

As another example shown in FIG. 3B, in the case where a layer 360 corresponding to a graphic image 350 in which the background of the character is an oblique line pattern includes 5×6 units including the code information and a layer 380 corresponding to a dot pattern graphic image 370 includes 7×8 units, when the oblique line pattern of the background is selected by a user, the 5×6 layer is arranged, and when the background is changed from the oblique line pattern to the dot pattern, the layer is also changed to the 7×8 layer.

The layers 360 and 380 include different numbers of unit areas for each of the background images 350 and 370 and different code information is arranged for each of the plurality of different units. Accordingly, when the background image is changed by a user, the layer and units are also changed according to the background image.

As described above, the character image 351 remains as it is in accordance with the operation of a user. However, as the background image is changed (350→370), the layer arranged corresponding to the graphic image of the background is changed together (360→380). Accordingly, the plurality of unit areas of the layer corresponding to the plurality of partial images (eyes, nose, mouth, feet, and the like) constituting the character image are changed, and thus the code information arranged in each unit is also changed.

That is, when the number of units constituting the layer is changed, the size of the unit is inevitably changed. Accordingly, the positions of each unit are changed, and the code information is also changed. A user may change the password by changing the character, but if a user likes the character and does not want to replace the character, a user may change the password by maintaining the character and replacing only the background image.

Accordingly, when the present invention is applied to services (e.g., electronic payment, electronic financial service, TOT controller, terminal device unlocking, etc.) in which passwords are used, a user can easily change the password by replacing a character, and can obtain the same effect as changing the password only by simply changing the background image.

The oblique lines or dotted background graphic images illustrated in FIG. 3B may include various kinds of patterns such as a stripe pattern, a dot pattern, a square pattern, a star pattern, a paisley pattern, and a plaid pattern. In addition to the patterns, various distinguishable colors such as yellow, blue, red, and other colors, or photo images depicting water, sky, or landscape and matching a character, can be used.

It is recommended to regularly change passwords at service providing servers in which the password input is required. However, since a user uses several server, not one server, a user cannot periodically change the password, and needs to generate a new password and then memorize the password whenever replacing the password. Accordingly, since a user cannot accurately remember all the many passwords that are added and replaced as times goes on, applications for a user to write passwords somewhere or to separately store the passwords have been developed, but there are still limitations in security.

However, as described above, when the main image (character) or the background image is changed by a user, the code information of the corresponding area is automatically changed together. Thus, the password can be easily and conveniently replaced without inconvenience or repulsive feeling to generate and memorize a new password whenever the password is replaced, thereby enhancing the security and preventing password hacking in advance.

Also, since a user inputs a password by touching specific parts of an image such as a non-repulsive and familiar character, picture, or photograph, it is easy for users including children, seniors and foreigners to use without any academic background, nationality, and knowledge difference.

For example, by touching “left eye→right eye→nose→right foot” of the pig character, it is easy to input “17, 19, 23, 34” which is a combination of code information “17” of the unit corresponding to “left eye”, code information “19” corresponding to “right eye”, code information “23” corresponding to “nose” and code information “34” corresponding to “right foot”.

As another example, by dragging the “left eye→right eye→nose→right foot” of the pig character to draw a pattern, it is possible to input “17, 19, 23, 34” which is a combination of code information “17” of the unit corresponding to “left eye”, code information “19” corresponding to “right eye”, code information “23” corresponding to “nose” and code information “34” corresponding to “right foot”.

In the above case, the input speed is faster and easier than the touch input, and the typical pattern password input system is vulnerable to ambient exposure in that the point display position (input position) for guiding the pattern input is exposed and the point positions are fixed and cannot be changed. Also, the already-familiar pattern to a user's hand cannot be easily changed into others. However, in the present invention, if only the character that is an image is replaced, since the positions of each part such as eyes, nose, mouth, and feet of each character are different, the pattern that are drawn may be changed, and thus the patterns used as passwords can be naturally changed, thereby reducing the possibility of exposure and increasing the security.

For example, when the pattern is drawn by dragging the “left eye→right eye→nose→right foot” of the pig character, the code information of the position corresponding to the “left eye” is determined to be “17”, and the position of “right eye” is checked according to the angle and the length dragged to the “right eye” based on the position corresponding to the “left eye”, and then the code information of the position corresponding to the “right eye” is determined to be “19”. Then, the position of “nose” is checked according to the angle and the length dragged to the “nose” based on the position corresponding to the “right eye”, and then the code information of the position corresponding to the “nose” is determined to be “23”. Then, the position of “right foot” is checked according to the angle and the length dragged to the “right foot” based on the position corresponding to the “nose”, and then the code information of the position corresponding to the “right foot” is determined to be “34”. Thus, the combined numbers “17, 19, 23, 34” may be inputted.

In addition, when viewing the pig and white bear characters which are password input images 310, 330, 350 and 370, since a password input button or a password input interface, which is necessarily displayed on the password input screen, is not separately displayed, a third party cannot know the components (password input buttons) for inputting the password on the input screen image and the selection order of the components. Accordingly, it is difficult for the third party except a user who sets the password to predict the password, and thus the security can be increased.

In addition, the password input screen is not the same keypad shape provided to everyone, and the graphic form of the input screen is different for each user. Also, the password input buttons are not displayed, and the set password input position is different for each user. Furthermore, the graphical form of the input screen is entirely changed when the password is replaced. Accordingly, even if the password input situation is exposed, it is difficult for a third party to know the input position, making it difficult to recognize or predict the password. Thus, it is not necessary to make the character (or number) combination difficult and long like a typical password method. Also, a user needs not to memorize the character on all such occasions, and can be free from generation of a new password, forgetting of a password, and input error due to a password change.

For example, a general keypad or password input screen has the same key shape or key position in order to reduce user input errors and improve convenience and readability. When the key shape or key position is changed, users are very confused when inputting a password. Also, due to the same input screen provided to all of users, although only the fingerprint or the finger position at the time of inputting the password is roughly known, it is possible to guess the key position and to perform a guessing attack.

Hereinafter, a process of receiving a preset service according to the validity of a password by the terminal device 100 independently of or in linkage with the service providing server 200 will be described.

For example, the process of receiving a preset service according to the validity of a password by the terminal device 100 may include unlocking of a tablet PC or a mobile phone. Also, the process of receiving a preset service according to the validity of a password by the terminal device 100 in linkage with the service providing server 200 may include a financial service, an electronic payment, and the like. In this case, the service providing server 200 may be implemented as a payment server, a financial company server, or the like.

Hereinafter, for convenience of explanation, the process of independently determining the validity of a password by the terminal device 100 will be described. However, according to the type of the service, the terminal device 100 may request the service providing server 200 to determine the validity of the password in linkage with the service providing server 200, and then may receive a preset service from the service providing server 200 according to the result of the validity determination of the password determined by the service providing server 200.

First, when receiving a selection signal on an image, the terminal device 100 extracts code information indicated by the selection signal from a layer area arranged corresponding to the image. That is, when the selection signal for a specific area of the image is received, the terminal device 100 determines a unit corresponding to the selection signal among the plurality of units constituting the layer, and extracts the code information assigned to the unit.

The terminal device 100 generates a password by using the code information assigned to the unit corresponding to the selection signal. In this case, when a password input completion signal is received, the terminal device 100 may generate a password using the extracted code information, or when the selection signal is not received for a specific time, the terminal device 100 may generate a password using the extracted code information.

Then, the terminal device 100 determines the validity of the password according to whether or not the inputted password matches a preset and stored password.

In one embodiment, the terminal device 100 checks whether or not the entire inputted password matches a preset password, and determines that the password is valid if the entire password matches the preset password. According to this embodiment, a determined service (e.g., electronic payment, financial service, mobile phone unlock, etc.) may be provided.

In another embodiment, when a portion of the inputted password matches a preset password, the terminal device 100 defines numbers except the portion of password as a dummy password, and determines that the inputted password is valid.

In this case, the dummy password is a meaningless one-time number generated by randomly touching arbitrary positions to disguise the position of the actual password when a user touches specific areas on the image to input the password.

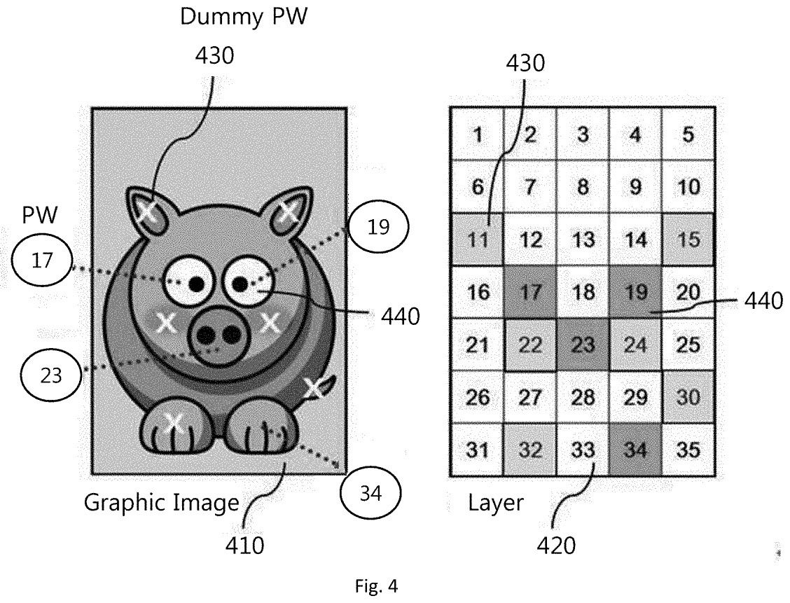

For example, as shown in FIG. 4, when 10 partial images (components) “left ear→right ear→left cheek→right cheek→tail→left foot→left eye→right eye→nose→right foot” are selected, the terminal device 100 may generate a password as “11, 15, 22, 24, 30, 32, 32, 17, 19, 23, 34” using the code information of each unit of the layer 420 arranged so as to correspond to the image 410.

In the above example, since the extracted password “11, 15, 22, 24, 30, 32, 17, 19, 23, 34” includes a number combination that matches numbers “17, 19, 23, 34” corresponding to “left eye→right eye→nose→right foot” that is a password 440 preset by a user, the numbers “11, 15, 22, 24, 30, 32” except “17, 19, 23, 34” are dummy passwords 430.

In this case, in order to extract the actual password except the dummy password, a string search algorithm such as Finite-state automaton based search, Brute Force algorithm, Knuth-Morris-Pratt algorithm and Rabin-Karp string algorithm, a pattern matching algorithm, or a pattern recognition algorithm may be used.

The dummy password may be used before and/or after the password.

Also, since the dummy password is intended to disguise the input position of the actual password, the value need not always be identical like the password, and since the dummy password is disposable, a user may freely input the random numbers to the random positions by an instant input operation.

That is, the dummy passwords may be freely and randomly inputted without limitation of input number, but it is preferable to limit the number of dummy passwords to 5 or less in consideration of exposure to a random touch input by the guessing attack.

Also, the dummy password may be randomly and instantly used through one or more touch inputs, and may be used or unused by a user's choice.

If a user inputs only the actual password without inputting the dummy password, the dummy password is not detected and only the password is detected.

When it is checked whether or not the extracted password matches a preset password and it is determined that the extracted password does not match the preset password, the extracted password is an invalid password and thus error processing is performed.

Generally, since a password is easily generated to be short and simple for the convenience of a user, the password can be easily leaked by the surrounding exposure, shoulder surfing, etc. However, if a dummy password is randomly inputted before and/or after the actual password is inputted, the password and the dummy password are exposed together. Accordingly, even if there is an observer for the shoulder surfing, the possibility that the password input positions and the number of password input are exposed can be reduced, thereby significantly increasing the security.

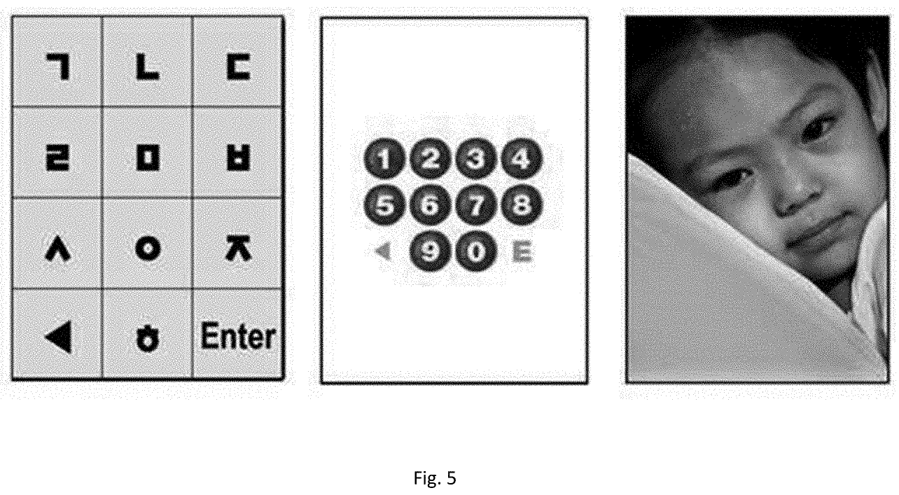

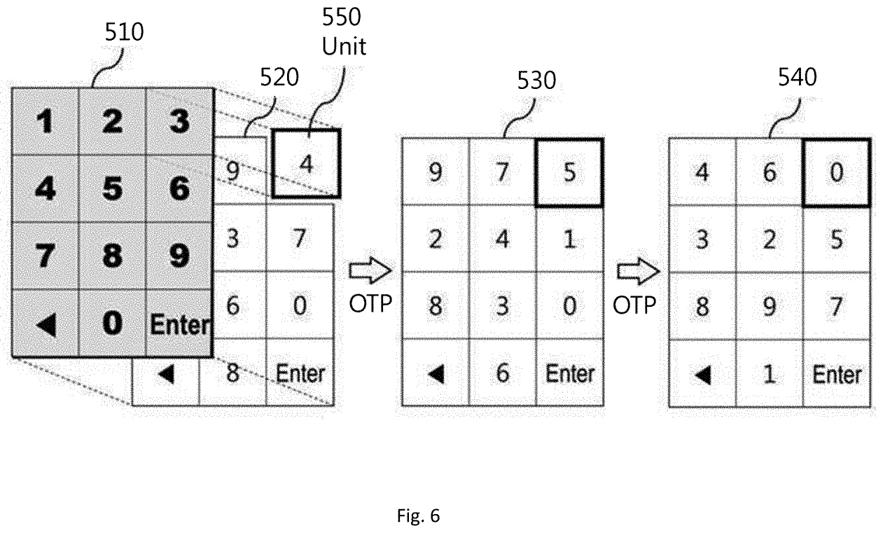

An image 510 shown in FIG. 5 is an example for explanation, and characters, special characters, symbols, icons, characters, pictures, and photographic images may be used for the image of the input screen as shown in FIG. 6.

Among the images, the typographic images include character images of each country such as numbers, Korean, English (including capital and small letters), Japanese, Chinese characters, and the like. In addition, special characters or symbol images can also be included in these typographic images.

As shown in FIG. 5, a numeric image 510 in which an image is configured with numbers will be described.

The numeric image 510 shown in FIG. 5 is divided into areas for each number. However, this is one graphic image as a whole and dividedly represented only on the image, and is for allowing a user to easily select partial areas (e.g., 1 to 0).

When the numeric image 510 represented by a plurality of numeric areas is used, the code information of each of units 550 of a layer 520 disposed corresponding to the numeric image 510 is changed.

In this case, the code information of each of the plurality of unit areas arranged in the layer may be randomly changed at a specific time interval, randomly changed by number of uses, or randomly changed over time based on One Time Password (OTP). For example, the code information of the layer 520 disposed corresponding to the numeric image 510 may be changed by the above-described method like the layer 530 and the layer 540.

For example, since the numeric image 510 that is a typographic image displayed to a user does not change, a user cannot know that the code information of the layer 520→530→540 has been changed. Also, the input value is inputted by touching the individual numbers on the numeric image 410, but the changed code information of the layer is inputted. That is, a user inputs “3” in the numeric image 510, but “4” is inputted by the unit 520 of the layer 520 in which the code information is changed. In the same manner, “5” is inputted by the unit of the layer 530, and then “0” is inputted by the unit of the layer 540.

This provides the same user-friendly input environment when a character password is inputted. Accordingly, it is possible to reduce the input delay and input error due to user inconvenience and confusion which are limitations of the random virtual keyboard method in which the keypad string is changed each time, and it is possible to conveniently and quickly input a password, thereby preventing ambient exposure and keylogging.

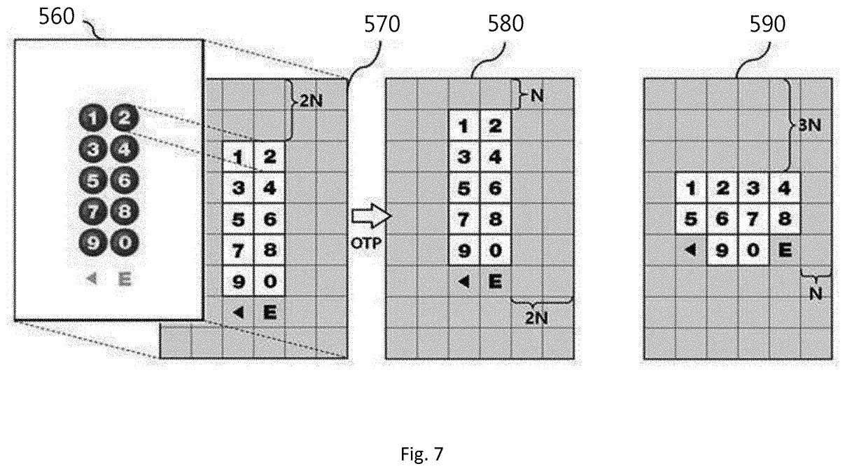

As another example, when the numeric image is configured with a typographic image 560 of a keypad shape of a portable terminal as shown in FIG. 7, the touch position may be changed only by the interval adjustment of the surrounding margin like reference numerals 570 and 580 without mixing the character arrangement or changing the character interval. Accordingly, since the readability can be increased and keylogging can be effectively prevented, the typographic image 560 can be used as a virtual keyboard having improved security and convenience.

In other words, for the same reason that different positions of layers disposed corresponding to the image are selected and the password are changed because the positions of the eyes and nose of the pig and white bear characters are different from each other as described above, when the typographic is changed, the layer corresponding thereto and thus the units of different positions may be selected. Accordingly, it is possible to effectively prevent keylogging which finds the input number of the virtual keyboard with the touch position values. In this case, since the typographic maintains the number shape, size, spacing, and arrangement and only the position of the peripheral margin is adjusted, a user perceives only the up and down and left and right movements of the screen and may not recognize that the input screen is changed.

The typographic used in this case may be adjusted in top, bottom, left and right interval around the characters according to the units of the layer as shown in 570 and 580 of FIG. 7, or the character lay-out may be adjusted as shown in 590 of FIG. 7. In this case, the typographic may be variously manufactured and used using a familiar character lay-out method (e.g., front row alignment, rear row alignment, center alignment, vertical alignment, and the like) which is widely used while not affecting readability.

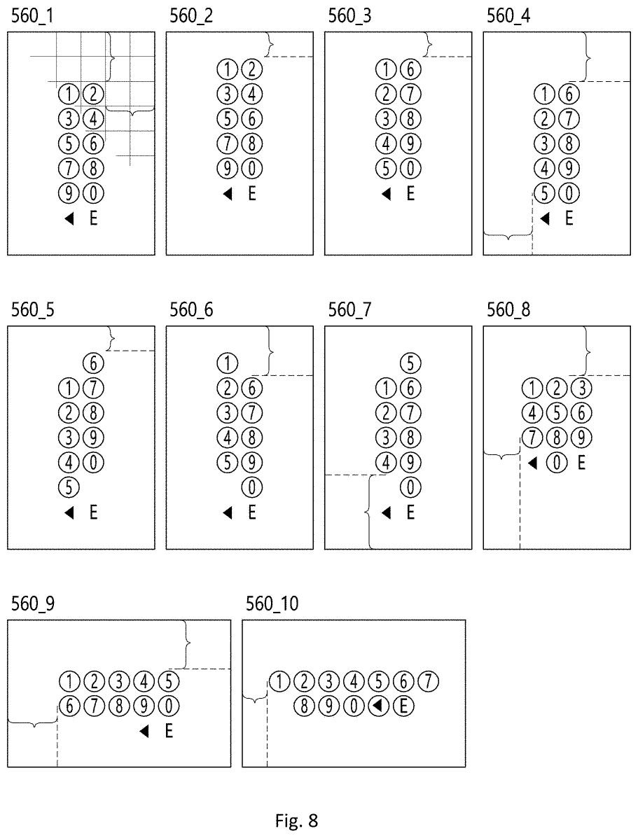

FIG. 8 illustrates a method of designing and laying out the typographic. A user touches a numeric input button of the typographic disposed on an input screen to input a password. In this case, since different positions are touched for each typographic, it can be seen that the input positions are different in spite of the same number.

Since the current password input key buttons of the virtual keyboard are disposed at the same position because the positions of the number are always fixed, if the touch position values are known, the input numbers are known, causing key logging.

The typographic of FIG. 8 show only a few examples of design and lay-out, and may be applied in various combinations and lay-outs.

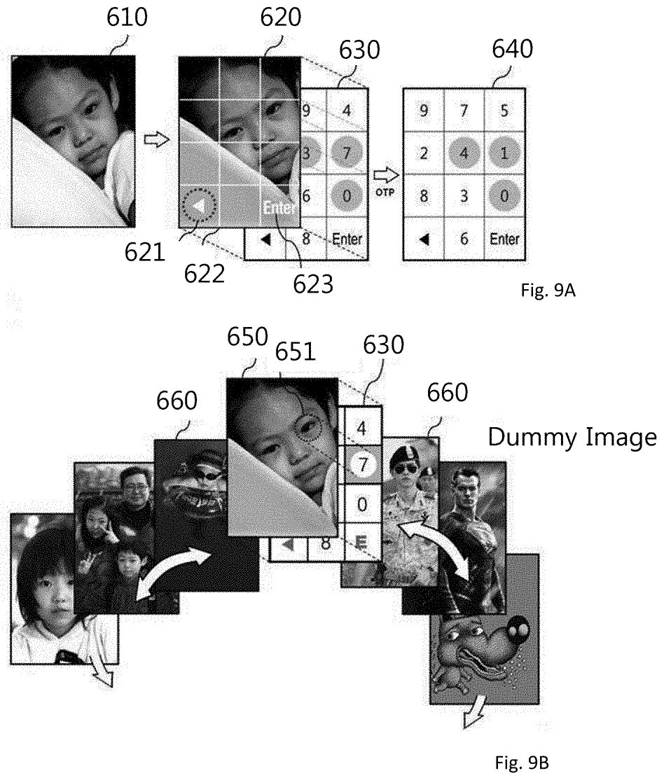

As another example, when the numeric image of the input screen is configured with a photographic image 610 of FIG. 9A, a grid of a layer 630 disposed corresponding to a photographic image 620 is displayed on the photographic image when a specific part (e.g., [symbol] ) 621 is touched. In this case, since a user may vertically or horizontally move the photographic image, enlarge or reduce the photographic image, or rotate the photographic image to adjust a specific part of the photographic image desired by a user to a password selection position, a user can select a unit disposed on the layer 630. That is, the boundary lines of each unit disposed on the layer are displayed as the grid on the picture, and a specific part of the picture is arranged so as to match the unit using the grid.

For example, when the size of the photographic image 610 is enlarged, reduced and adjusted such that a specific part (e.g., right eye, left eye, mouth) 651 of the photographic image 620 does not cover the grid line 622 of the layer and then the “right eye→right eye→left eye→mouth” of a kid in the photographic image are selected, code information “7, 7, 3, 0” of units of the layer 630 disposed corresponding to the photographic image 620 is inputted as a password. Thus, it is possible to input a password which cannot be used in the photographic image because a selection value of a specific part cannot be designated on the photographic image.

In this case, the number of units arranged in the layer may be changed by a user. As the number of units increases, the size of the unit area becomes smaller. Accordingly, more positions and a smaller part can be selected on the photographic image corresponding to the layer.

On the other hand, there is no limitation in size of the grid. In FIGS. 9A-9B, although it is illustrated that the screen is divided into twelve screens by the grid, a grid of a size large enough to divide the screen into two may be used, or a grid of a small size including few pixels may be used.

In FIGS. 9A-9B, a plurality of squares of the same size are uniformly arranged in the left and right directions. However, the grid may be implemented such that a plurality of figures having different sizes are irregularly arranged at different positions.

When an input completion signal (e.g., E, Enter) 623 is detected, the grid and buttons on the photographic image disappear and only the photographic image remains on the input screen as shown in 650 of FIG. 9B. Thus, a third party cannot recognize the photographic image as the password input screen, and can view only the photographic image like a photo album.

On this input screen of the terminal device, a plurality of photographic images such as photographs directly taken, family photographs, animal photographs, celebrity photographs or graphic images such as characters, pictures, and cartoon cuts may be together arranged. In this case, it is not possible to distinguish which photographic image is the password input screen except a user, and as the number of the photographic images 660 together arranged increases, the security also increases. This is because it is difficult to find the photographic image 650 for inputting the password among the plurality of photographic images and select a partial image 651 again to input the password.

That is, if the above-mentioned dummy password is intended to disguise the input button, the input position, and the number of times of input, this device acts as a sort of a dummy image which mixes and disguises the input screen image with a plurality of images, thereby preventing a third party from recognizing the input screen and increasing the password security.

The number of images to be dummy images may be selected or added by a user, or N images may be automatically set as dummy images. Also, the number and order of dummy images may be dynamically changed, thereby making it more difficult for a third party to recognize.

In this case, a user may take preferred images from the photo album of the terminal device and dispose the images together with the password input screen, and the dummy image may be set to be used or unused according to a user's selection.

This series of processes is a complicated process for a third party, but is simple and easy for a user who performs setting due to the characteristics of an image. The user authentication method of Graphic Image Password (GIP) system uses those characteristics of an image.

For example, when the lock screen of the terminal includes a plurality of photos, the lock screen acts as a photo album such that a user can view the photo album by scrolling left or right or up and down. In this case, a user can immediately know which one of the plurality of photos arranged on the screen is a password photo for input, but a third party cannot know the photo for input and can just view the photo. Since learning and recognition information such as user's experience, habit and learning and emotional information such as feeling, emotion and preference which cannot be distinguished by the visual sense is included in an image in addition to visual image information such as pixel value, color value, brightness value and chroma value that can be distinguished by eyes, only a user can immediately recognize and distinguish the image even though his/her family and friends are mixed in similar images such as a plurality of portrait photos or various kinds of dog photos.

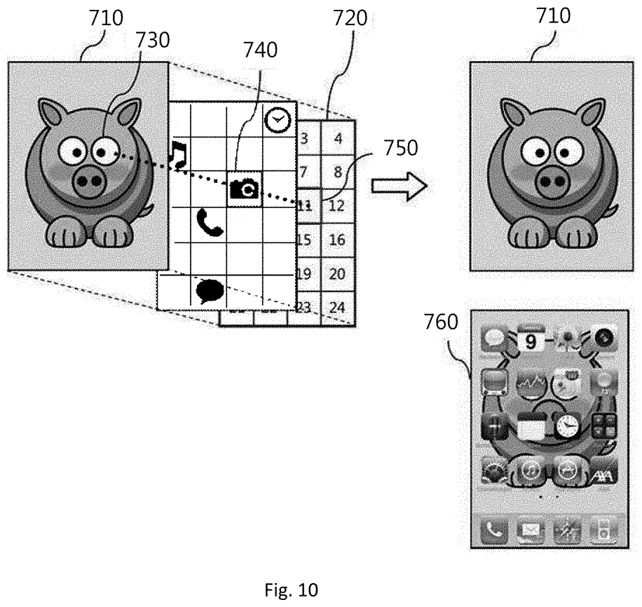

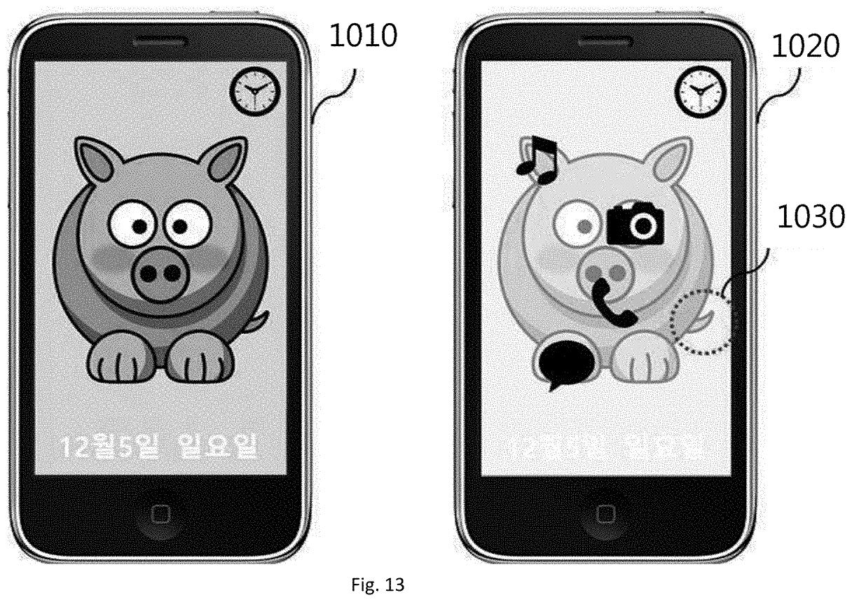

FIGS. 10 to 13 are views illustrating a supplementary service providing method using an image password system according to another embodiment of the present invention.

Referring to FIGS. 10 to 13, in order to execute an application in the terminal device 100, a user needs to find and touch the application (hereinafter, referred to as an app) icon. However, when there are a large number of apps that are used, since the number of app icons displayed on the screen of the terminal device 100 increases, it is not easy to find an app icon that a user desires to use, thereby causing inconvenience.

For this reason, a user places frequently used apps on the initial screen or wallpaper as shortcut icons. However, even if the background screen of the terminal device is decorated with a favorite photo or image, the screen may be covered with many shortcut icons and thus the meaning of setting the background screen may be lost (760 in FIG. 10).

Accordingly, in this embodiment, when shortcut icons are set for each of the components of an image and then a user selects a specific component of the image, a pre-designated shortcut icon may be executed.

For this, as shown in FIG. 10, the terminal device 100 generates a layer 720 configured with a plurality of units 750 so as to correspond to a plurality of components (e.g., ear, eye, nose, mouth, foot, etc.) 730 constituting an image 710, and disposes the layer 720 so as to correspond to the image 710.

In this case, code information may be arranged in each of the plurality of units 750 constituting the layer 720. The code information may be an icon (e.g., a camera function icon, etc.) 740 that indicates a particular function.

Accordingly, when a selection signal for a specific component 730 among the plurality of components constituting the image 710 is received, the terminal device 100 determines a unit 750 corresponding to the selection signal among the plurality of units constituting the layer 720, extracts the code information assigned to the unit 750, and then executes a specific function that the code information indicates.

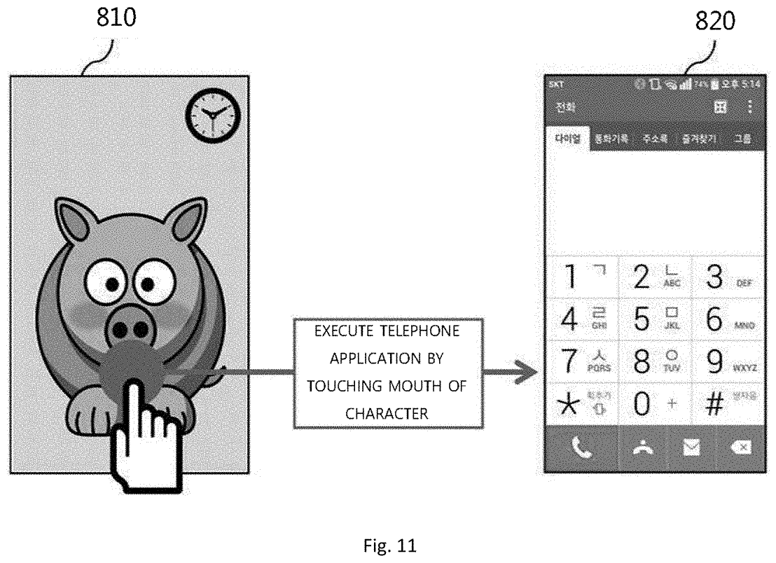

For example, when a selection signal for “mouth” is received among a plurality of components constituting an image 810 as shown in FIG. 11, the terminal device 100 selects a unit corresponding to “mouth” and extracts code information assigned to the unit. Then, if the code information indicates a call function, the terminal device 100 may execute the call function like the reference numeral 820.

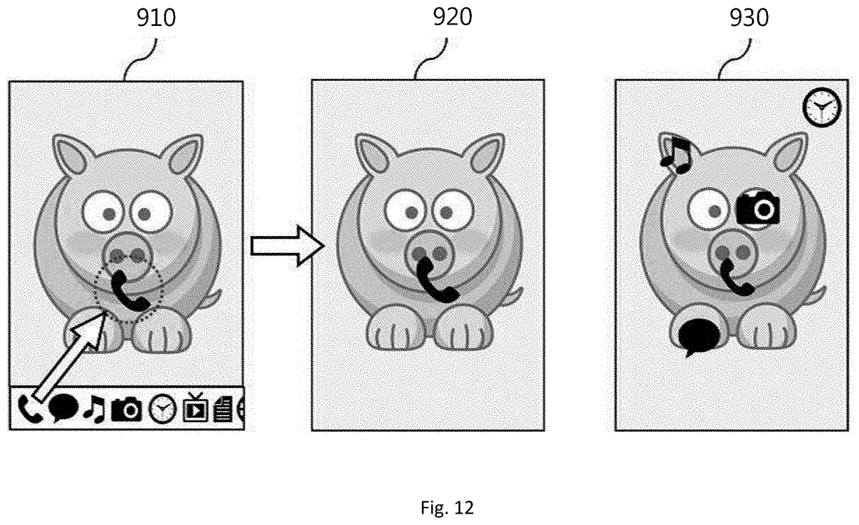

For this service, the terminal device 100 provides a user with an interface and a procedure for setting a shortcut key for each of a plurality of components of the image. For example, the terminal device 100 displays an image 910 selected by a user as shown in FIG. 12, and a list of apps to be set to shortcuts is displayed as icons at the bottom of the image. In this case, when the list of apps is large, a user may scroll the list left and right to see hidden app icons.

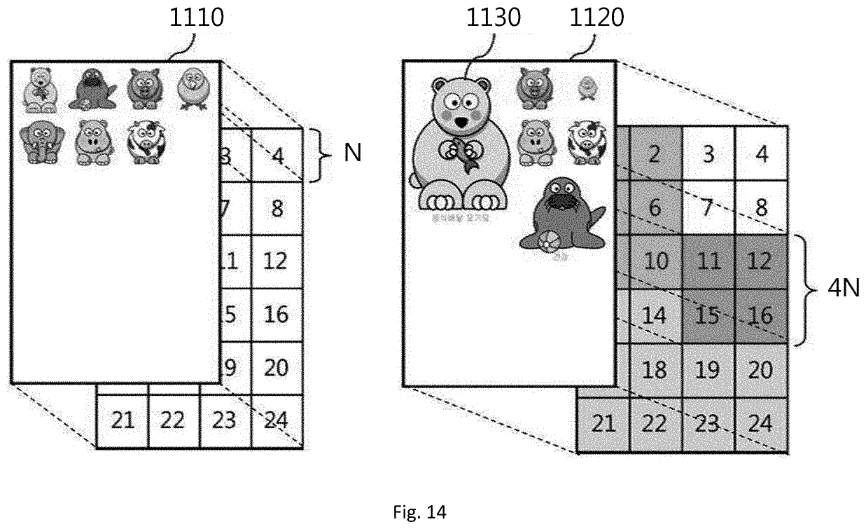

FIG. 14 is a view illustrating a supplementary service providing method using an image password system according to another embodiment of the present invention.

Referring to FIG. 14, when a character located at a certain area of a plurality of unit areas constituting a layer is selected and a selection signal is received, the terminal device 100 extracts code information indicated by the selection signal.

Then, the terminal device 100 extracts app information corresponding to the code information with reference to an app information table for each code information, and executes the corresponding app.

For example, when a specific icon 1130 is selected by a user as in 1120 of FIG. 14 and a selection signal is received, the terminal device 100 extracts code information “1, 2, 5, 6, 9, 10” indicated by the selection signal. Then, the terminal device 100 may extract a “delivery food order application” which is app information corresponding to “1, 2, 5, 6, 9, 10” with reference to an app information table for each code information, and may execute the “delivery food order application”.

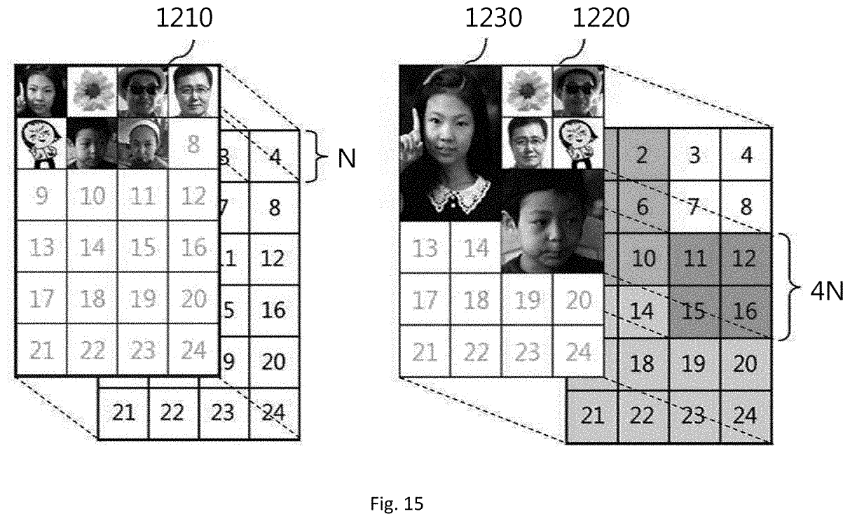

FIG. 15 is a view illustrating a supplementary service providing method using an image password system according to another embodiment of the present invention.

Referring to FIG. 15, when an image located at a certain part of a plurality of unit areas constituting a layer is selected and a selection signal is received, the terminal device 100 extracts code information indicated by the selection signal.

Then, the terminal device 100 extracts a telephone number corresponding to the code information with reference to a telephone number information table for each code information, and performs connection to the corresponding telephone number.

As described above, when a specific image 1230 is selected by a user as in the reference numeral 1220 in FIG. 15 and a selection signal is received, the terminal device 100 extracts code information “1, 2, 5, 6, 9, 10”. Then, the terminal device 100 may extract contact information “010-0000-0000” corresponding to “1, 2, 5, 6, 9, 10” with reference to a contact information table for each code information, and may perform a call connection to “010-0000-0000”.

1-20. (canceled)

21. A user authentication method using an image password system executed in a terminal device, the method comprising:
receiving a selection signal through an area of an image;
extracting code information indicated by the selection signal among specific components constituting the image;
generating a password using the extracted code information; and
determining the validity of the password according to whether or not the password matches a preset password,
wherein:
the selection signal is generated from a target designated by a user among the specific components constituting the image;
when the image is changed, the code information is changed if the same target designated by a user is inputted; and
the password is changed in real-time in accordance with the change of the code information.

22. The method of claim 21, wherein: in the extracting of the code information,
the selection signal is generated from a target designated by a user among the specific components constituting the image;
when the image is identical, the code information is changed in accordance with the number of times, time, and One Time Password (OTP) if the target designated by a user is inputted; and
the password is changed in real-time in accordance with the change of the code information.

23. The method of claim 21, wherein the extracting of the code information indicated by the selection signal comprises:
determining a unit corresponding to a selection signal among a plurality of units when the selection signal for a specific area of the image is received; and
extracting code information assigned to the unit.

24. The method of claim 21, wherein the generating of the password using the extracted code information comprises generating a password using the extracted code information if a password input completion signal is received or the selection signal is not received for a specific time.

25. The method of claim 24, comprising determining, if a partial number of the passwords matches the preset password, the validity of the password by ignoring a dummy password which is numbers before and/or after the partial number is extracted.

26. The method of claim 25, wherein the dummy password comprises at least one of numbers, letters, special characters and symbols of one or more digits which are randomly and instantly inputted, and is used or not used according to a user's selection.

27. The method of claim 21, further comprising:
generating a layer comprising a plurality of units of different numbers so as to correspond to a plurality of components constituting the image; and
laying out the layer so as to correspond to the image.

28. The method of claim 27, wherein the generating of the layer comprises arranging code information in each of the plurality of units of the layer.

29. The method of claim 28, wherein the arranging of the code information in each of the plurality of units of the layer comprises arranging the code information comprising at least one of numbers, letters, special characters, and symbols in each of the plurality of units of the layer.

30. The method of claim 28, wherein the arranging of the code information in each of the plurality of units of the layer comprises randomly changing the code information in each of the plurality of units of the layer at a specific time interval, randomly changing the code information by number of times, or randomly changing the code information according to time based on a One Time Password (OTP).

31. The method of claim 21, further comprising:
providing a password setting procedure according to a user's password setting request;
sequentially selecting a specific component among a plurality of components constituting the image through the password setting procedure; and
determining and storing the password of a user using code information of each unit of the layer corresponding to the sequentially selected specific component.

32. The method of claim 31, further comprising:
changing the layer corresponding to the image if the image is changed by a user; and
updating the password of a user using code information of each unit of the layer corresponding to a component selected by a user from the changed image.

33. The method of claim 32, wherein the updating of the password of a user comprises updating the password of a user using the code information of each unit of the layer corresponding to the component selected by a user when arrangement information of the layer corresponding to the image and arrangement information arranged in each of the plurality of units are updated.

34. The method of claim 32, wherein the updating of the password of a user comprises updating the password of a user using the code information of each unit of the layer corresponding to the component selected by a user when the position of the component selected by a user is changed according to the change of the image by a user.

35. The method of claim 21, further comprising:
providing an application icon setting procedure;
disposing an application icon on a specific component among a plurality of components constituting the image through the application icon setting procedure; and
generating an application information table for each code information by storing application information set by a user using code information of each unit of a layer corresponding to the specific component.

36. The method of claim 35, further comprising:
extracting the code information indicated by the selection signal;
extracting application information corresponding to the code information with reference to the application information table for each code information; and
executing an application corresponding to the application information.

37. The method of claim 21, further comprising:
providing a telephone number favorite setting procedure;
disposing a user image in a unit constituting a layer through the telephone number favorite setting procedure; and
generating a telephone number information table for each code information using code information of each unit of a layer corresponding to the user image.

38. The method of claim 37, further comprising:
extracting the code information indicated by the selection signal;
extracting a telephone number corresponding to the code information with reference to the telephone number information table for each code information; and
performing a call connection using the telephone number.
